(19) United States
(12) Patent Application Publication
(10) Pub. No.: US 2018/0079033 A1
(43) Pub. Date: Mar. 22, 2018

(54) Plant For An Additive Production Method

(71) Applicant: Siemens Aktiengesellschaft, Muenchen (DE)

(72) Inventors: Ursus Krueger, Berlin (DE); Daniel Reznik, Berlin (DE)

(73) Assignee: Siemens Aktiengesellschaft, Muenchen (DE)

(21) Appl. No.: 15/560,735

(22) PCT Filed: Mar. 10, 2016
(86) PCT No.: PCT/EP2016/055153

§ 371 Date: Sep. 22, 2017

(30) Foreign Application Priority Data
Mar. 24, 2015 (DE) 10 2015 205 314.8

(51) Int. Cl. B23K 26/342; B33Y 30/00; B23K 15/00; B23K 26/12; B23K 26/70

(52) U.S. Cl. CPC B23K 26/342; B33Y 30/00; B23K 26/702; B23K 26/127; B23K 15/0086

(57) ABSTRACT

The present disclosure relates to plants for an additive production method. The teachings thereof may be embodied in a plant with a process chamber including a device for accommodating a powder bed. For example, a plant for an additive production method may include: a process chamber accommodating a structure for a powder bed; a bottom structure and a side boundary for the powder bed; a heating device; and a thermal insulation structure surrounding the powder chamber on the side boundary. The insulation structure may include a trough-shaped recess. The structure for the powder bed may be inserted into the trough-shaped recess of the insulation structure.

### CROSS-REFERENCE TO RELATED APPLICATIONS

This application is a U.S. National Stage Application of International Application No. PCT/EP2016/055153 filed Mar. 10, 2016, which designates the United States of America, and claims priority to DE Application No. 10 2015 205 314.8 filed Mar. 24, 2015, the contents of which are hereby incorporated by reference in their entirety.

### TECHNICAL FIELD

The present disclosure relates to plants for an additive production method. The teachings thereof may be embodied in a plant with a process chamber including a device for accommodating a powder bed.

### BACKGROUND

In one example, a plant for selective laser melting provides a powder bed layered on a heatable build plate. The build plate serves as a base for the component to be produced which is also heated via the build plate. In this case, process temperatures of up to 500° C. are available. In comparison to the component being produced, the powder bed is a poor heat conductor. The heating of the powder via the build plate therefore becomes increasingly more difficult during continuous production of the component since the powder particles of the respectively new layers of the powder bed are increasingly more distant from the build plate. As a result, the temperature regulation of the component also becomes increasingly more difficult, wherein the heat from the component can be dissipated both to the powder bed, which is no longer sufficiently heated, and upward into the process chamber.

Temperature regulation of the component may include an induction coil so that the component is inductively heated. The induction coils which are used are in this case moved relative to the powder bed and to the component being formed, to adjust the region of the heat generation in the component can be influenced. The introduction of heat by induction is dependent on the geometry of the component. A uniform heating of the component can only be achieved with comparatively simple component geometries and a compact type of construction of the component. In the case of more complex geometries, such as cross-sectional jumps or undercuts, the forming of eddy currents in the component being formed is disturbed and heterogeneous heating of the component occurs.

### SUMMARY

A plant incorporating the teachings of the present disclosure may provide a top-open powder chamber. By means of an energy beam, e.g., a laser beam or an electron beam, the powder in the powder bed can be melted in layers forming a component which is to be produced. The powder chamber may comprise a trough consisting of a bottom structure and a side boundary. Furthermore, the plant may include a heating device for the powder chamber, by means of which both the powder bed and the component which is being formed in the powder bed, that is to say the component to be produced, can be temperature regulated.

Some embodiments may include a plant for an additive production method, having a process chamber (12), in which is provided a device (29) for accommodating a powder bed (13). The device has a top-open powder chamber with a bottom structure (25) and a side boundary (24) for the powder bed (13). There may be a heating device (23) for the powder chamber. Some embodiments include a thermal insulation structure (26) which surrounds the powder chamber on the side boundary (24), characterized in that the insulation structure (26) is of trough-shaped design, wherein the device (29) for accommodating the powder bed is inserted into a trough-shaped recess of the insulation structure.

In some embodiments, the insulation structure (26) and the device for accommodating the powder bed (29) have a temperature resistance of at least 800° C.

In some embodiments, the insulation structure has a thermal conductivity of at most 0.5 W/mK.

In some embodiments, the insulation structure (26) consists of a porous mineral material, especially expanded perlite.

In some embodiments, the side boundary (24) and/or the bottom structure (25) has/have a thermal conductivity of at least 20 W/mK.

In some embodiments, the side boundary (24) and/or the bottom structure (25) consists of a metal, especially copper, molybdenum or tungsten, and/or of a ceramic, especially silicon carbide, boron nitride or aluminum nitride.

In some embodiments, the side boundary (24) and/or the bottom structure (25) have a wall thickness of at least 10 mm.

In some embodiments, the heating device is embedded into the bottom structure (25) and/or into the side boundary (24).

In some embodiments, the bottom structure (25 forms a build platform (20) for components to be produced.

In some embodiments, the bottom structure (25) is vertically displaceable in the side boundary (24).

In some embodiments, the bottom structure (25) is sealed at the side boundary (24) by means of a brush seal (33).

In some embodiments, the insulation structure (26) together with the device (29) for accommodating the powder bed (13) form a module (27) which is inserted in a holding device (28) in the process chamber (12).

In some embodiments, there is a plurality of modules (27) which fit into the holding device (28) and differ from one another in respect to the dimensions of the powder chamber.

### BRIEF DESCRIPTION OF THE DRAWINGS

Further details of the disclosure, are described below with reference to the drawing. The same or corresponding drawing elements are provided in each case with the same designations and are explained more than once only insofar as differences between the individual figures occur.

FIG. 1 shows schematically in section an exemplary embodiment of the plant according to the teachings of the present disclosure; and

FIGS. 2 and 3 show schematically in section exemplary embodiments for devices for accommodating a powder bed, suitable to be fitted into the plant shown in FIG. 1 since they are designed as a module.

### DETAILED DESCRIPTION

The teachings of the present disclosure may be used to control the temperature regulation of the component as far as possible over its entire volume and especially to create a homogeneous time-based temperature profile in the entire component. In particular, the rapid cooling down of the melt bath and of the newly produced component region may be slowed down in a targeted manner in the process. As a result, residual stresses are reduced. Also, the cooling down speed in the component is of significance if specified structure states are to be achieved.

For example, in the case of components consisting of nickel-based super alloys it is important for the establishing of the high temperature stability that a high proportion of γ′-precipitations is present in the structure. These are formed, however, only if the component is cooled down more slowly than about 1° C./s below the γ′-solidus temperature of approximately 1150° C. During the production of components consisting of a nickel-based superalloy, it is therefore desirable to limit cooling down of the component in the proximity of the melt bath to this cooling down temperature (at least below the γ′-solidus temperature).

Some embodiments may include a device for accommodating the powder bed having a thermal insulation structure surrounding the powder chamber, which surrounds the powder chamber on the side boundary and beneath the powder chamber. A thermal insulation structure includes a body which in comparison to the side boundary has a lower thermal conductivity so that the heat stored in the component to be produced and in the powder bed is slowed down via the side boundary. The cooling down speed in the component is also reduced and effective temperature regulation of the powder bed and of the component being produced can be carried out by means of the heating device.

In particular, it is possible to bring about a uniform temperature regulation in the powder bed even in layers which are at a distance from the base for the production of the component (build plate, which can be provided by the bottom structure or is fastened on the bottom structure). As a result of this, it is especially possible to control the cooling down speed in the component being produced, as a result of which stresses forming in the component are reduced. Furthermore, the forming of specific structure states can be achieved on account of diffusion processes in the structure. These state may only be established if the cooling down speed is not excessively high (for example the forming of γ′-precipitations in components consisting of a nickel-based super alloy, as are used for example for the production of turbine blades).

In some embodiments, the insulation structure is trough-shaped, wherein the device for accommodating the powder bed is inserted into the trough-shaped recess of the insulation structure. This insulation structure brings about an insulation not only on the side boundary but also beneath the bottom structure. The bottom structure can be fixedly connected to the insulation structure or be arranged beneath the bottom structure in such a way that the bottom structure can be moved independently of the insulation structure. The bottom structure may be axially movable in the vertical direction so that this can be lowered in stages during the production of the powder layers in order to keep the level of the surface of the powder bed constant. For an actuator for moving the bottom structure, a suitable recess or opening can be provided in the insulation structure.

In some embodiments, the insulation structure and the device for accommodating the powder bed have a temperature resistance of at least 800° C. This may ensure that even higher temperatures for temperature regulation of the powder bed and of the component to be produced are possible. For example, temperature regulation of a powder consisting of a nickel-based super alloy can be carried out at 1000° C. so that the temperature difference to the produced component upon achieving the γ′-solidus temperature constitutes only 150° C. Consequently, a cooling down speed of 1° C./s is ensured.

In some embodiments, the insulation structure has a thermal conductivity of at most 0.5 W/mK. This thermal conductivity may lead to an effective thermal insulation of the powder bed toward the outside. The insulation structure can consist of a porous mineral material. As a material, expanded perlite may be used. This is produced by heating raw perlite at temperatures of 800-1000° C. and at the same time has a high temperature resistance and a low density. Thermal conductivities of 0.04 to 0.07 W/mK can be achieved with expanded perlite so that a high thermal insulation capability of the insulation structure is advantageously ensured.

In some embodiments, the side boundary and/or the bottom structure has/have a thermal conductivity of at least 20 W/mK. This allows the heat from the heating device to be dissipated quickly to the outer particles of the powder bed. At the same time, the thermal insulation structure dissipates the heat of the heating device only in small measure into the surrounding of the device for accommodating the powder bed. This may limit the energy expenditure for temperature regulation of the powder bed and at the same time improve the homogeneity of the temperatures prevailing in the powder bed and also in the component to be produced.

In some embodiments, the side boundary and/or the bottom structure can consist of a metal such as copper, molybdenum, or tungsten, and/or a ceramic, especially silicon carbide, boron nitride, or aluminum nitride. These examples have a sufficient temperature resistance for temperature regulation even for high temperatures. Apart from that, the metals are very good heat conductors. The ceramics may reduce the adhesion capability of particles on the side boundary and the bottom plate. To combine the advantages of a high thermal conductivity with the advantages of a low adhesion capability of the particles, in some embodiments the side boundary and/or the bottom structure are produced from a metal with a ceramic coating adjoining the powder bed.

In some embodiments, the side boundary and/or the bottom structure has a wall thickness of at least 10 mm. Then the heating device, e.g. an electric resistance heater, can be embedded into the bottom structure and/or the side boundary. At the same time, the wall thickness of the side boundary and/or of the bottom structure ensures an adequate thermal capacity so that the heat which is generated in the heating device can be temporarily stored and homogeneously dissipated to the adjoining powder bed or to the workpiece which is lying on the bottom plate.

If the bottom structure, as already mentioned, is vertically displaceable, the bottom structure may be sealed on the side boundary by means of a brush seal. In other words, the bristles of the brush seal, which may be anchored in a vertically radially outward manner in the bottom structure, are located in the gap between the bottom structure and the side boundary. The brush seal may compensate tolerances which for example could be caused by particles adhering to the sidewalls. Furthermore, the brush seal prevents the powder trickling through the gap between bottom structure and side boundary. If the brush seal is produced from a material with a thermally good conductivity, such as metal, a good heat transfer between the side boundary and the bottom structure is also ensured. As a result of this, the temperature level prevailing in the side boundary and in the bottom structure may be standardized. In some embodiments, there is a heating device only in the bottom structure or only in the side boundary, wherein the heating of the other structure is ensured via the brush seal.

In some embodiments, the insulation structure together with the device for accommodating the powder bed form a module inserted in a holding device in the process chamber. This enables the creation of a construction kit which consists of a plurality of modules which fit into the holding device and differ from each other in respect to the dimensions of the powder chamber. In some embodiments, a uniform temperature regulation of the component being produced is improved if the powder bed is as small as possible with regard to the dimensions of the component to be produced. In other words, as a result of this measure, the paths which the heat has to travel from the side boundary or the bottom plate to the component being produced in the powder bed are minimized. Since the powder in comparison to the component and to the side boundary and also to the bottom structure is a poor heat conductor, as a result of this the insulating effect of the powder can be advantageously minimized. At the same time, the component can be advantageously produced with a low use of powder, which is particularly advantageous in the case of expensive materials.

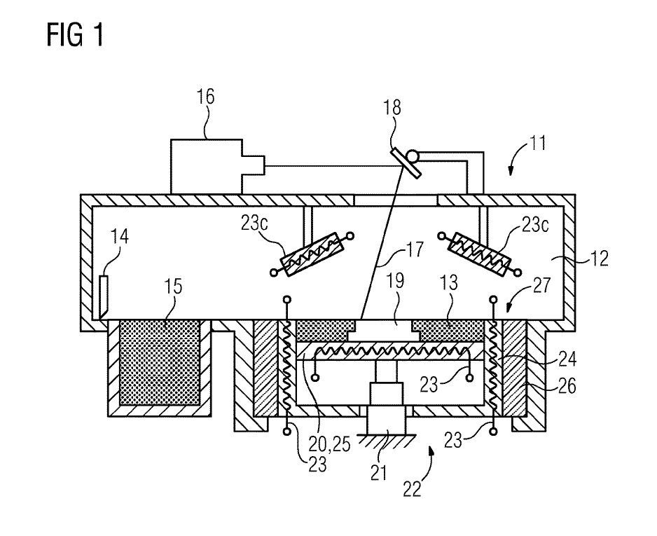

FIG. 1 is a drawing showing a schematic for a plant 11 for laser melting. The plant 11 may include a process chamber 12 in which a powder bed 13 can be produced. For producing a layer of the powder bed 13, a distribution device in the form of a doctor blade 14 is moved over a powder supply 15 and then over the powder bed 13, as a result of which a thin layer of powder is formed in the powder bed 13. A laser 16 then generates a laser beam 17 which by means of an optical deflection device with a mirror 18 is moved over the surface of the powder bed 13. In the process, the powder at the impact point of the laser beam 17 is melted, forming a component 19.

The powder bed 13 is formed on a build platform 20, which via an actuator 21 in a cup-shaped housing 22 can be lowered in steps by a powder layer thickness in each case. In the housing 22 and the build platform 20, heating devices 23 in the form of electric resistance heaters can preheat the component 19 being formed and the particles of the powder bed 13.

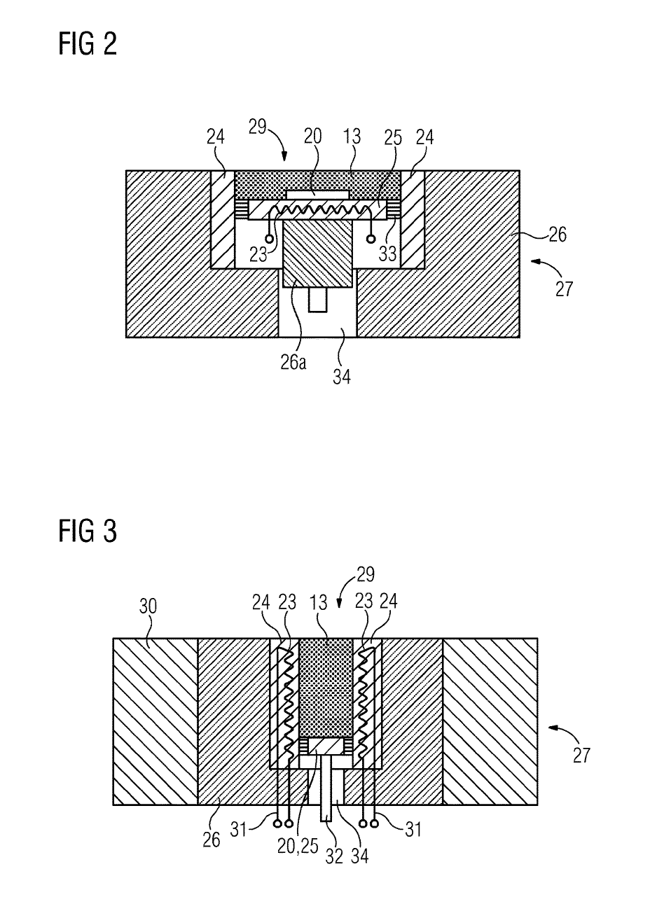

The housing 22 forms with its sidewalls a side boundary 24 which bounds the powder bed 13 toward the sides. Toward the bottom, the powder bed 13 is bounded by the build platform 20 which at the same time constitutes a bottom structure 25 as the lower boundary for the powder bed 13 (cf. also bottom structure 25 according to FIG. 2). On the outside on the side boundary 24 provision is furthermore made for an insulation structure 26 which surrounds the side boundary 24 in a shell-like manner and is fixedly connected to this. The housing 22 together with the fixedly mounted insulation structure 26 form a module 27 which can be inserted in a holding device of the process chamber.

Furthermore, outside the device 27 for accommodating the powder bed, there may be external heating devices 23e so that heat loss via the surface of the component 19 or the surface of the powder bed 13 is reduced. In this case, the transfer of heat may be carried out by thermal radiation, that is to say in a contactless manner.

Shown in FIGS. 2 and 3, the device 29 including the side boundary 24 and the bottom structure 25 for accommodating the powder bed 13 can also be part of a module 27, wherein the insulation structure 26 according to FIG. 2 determines the outside dimensions of the module 27 and therefore at the same time undertakes the function of an adapter. As can be seen by a comparison of FIG. 2 and FIG. 3, the modules 27 may have the same dimensions. It can also be gathered from FIG. 3 that if the device 29 for accommodating the powder bed 13 has very small dimensions, an additional adaptor component 30 can be used if the insulation structure 26, taking into account the maximum necessary thickness, does not totally fill the volume of the module.

It can also be gathered from FIG. 3 that the module 27 is equipped with electrical connections 31 for the heating structures 23 and with a mechanical connection 32 for connecting an actuator for the vertical movement of the bottom structure 25. The connections are designed so that an exchange of the modules can be carried out without any problem. The modules therefore form a construction kit system and can all be used in the same plant 11.

It can also be seen in FIG. 2 that a build platform 20 is provided on the bottom structure 25 as a separate component. This may comprise a good heat conductor, e.g. metallic. These embodiments may allow the build platform to be dismantled if the surface for example has to be after machined after repeated production of components.

It can also be seen in FIG. 2 that the heating device 23 is only shown in the bottom structure 25. The bottom structure is sealed toward the side boundary 24 by means of a metal brush seal 33 so that on the one hand the powder of the powder bed 13 cannot trickle past at the outer edge of the bottom structure 25 and on the other hand a heat transfer from the bottom structure 25 into the side boundary 24 can be carried out.

To transfer the heat which is generated by the heating device 23 to the powder bed 13 and to the side boundary 24 without minimal losses, the bottom structure 25 may be fixedly connected to a part of the insulation structure 26a. This is consequently displaced together with the bottom structure 25 in the vertical direction and largely seals an opening 34 in the insulation structure 26 beneath the bottom structure 25 so that heat loss through this opening 34 is largely prevented. The opening 34 is required for mechanically connecting the bottom structure 25 to an actuator so that the bottom structure 25 can be moved in the vertical direction.

Shown in FIG. 3 is that the heating device 23 may be only in the side boundary 24, whereas the bottom structure 25 does not have a heating device. If the volume of the powder bed 13 according to FIG. 3 is compared with that according to FIG. 2, then it shows that the component to be produced can have a greater height in relation to the base area than in FIG. 2. Due to this, the heat loss via the bottom structure is not so great in proportion, which makes heating of the bottom structure 25 superfluous. It can even be provided that the bottom structure 25 is (at least largely) thermally decoupled from the side boundary 24, for example via a ceramic seal 35 with poor thermal conductivity so that heat from the component to be produced can be transferred in a targeted manner to the bottom structure 25 (which at the same time is used as the build plate 20). The amount of dissipated heat can be used in a targeted manner in order to cause a controlled cooling down of the component being formed.

What is claimed is:

1. A plant for an additive production method, the plant comprising:
a process chamber accommodating a structure for a powder bed;
a top open powder chamber having a bottom structure and a side boundary for the powder bed;
a heating device for the powder chamber; and
a thermal insulation structure surrounding the powder chamber on the side boundary;
wherein the insulation structure comprises a trough-shaped recess; and
the structure for the powder bed is inserted into the trough-shaped recess of the insulation structure.

2. The plant as claimed in claim 1, wherein the insulation structure and the structure for the powder bed have a temperature resistance of at least 800° C.

3. The plant as claimed in claim 1, wherein the insulation structure has a thermal conductivity of at most 0.5 W/mK.

4. The plant as claimed in claim 3, wherein the insulation structure comprises a porous mineral material.

5. The plant as claimed in claim 1, wherein at least one of the side boundary and the bottom structure has a thermal conductivity of at least 20 W/mK.

6. The plant as claimed in claim 5, wherein at least one of the side boundary and the bottom structure comprises copper, molybdenum, tungsten, silicon carbide, boron nitride, or aluminum nitride.

7. The plant as claimed in claim 1, wherein at least one of the side boundary and the bottom structure have a wall thickness of at least 10 mm.

8. The plant as claimed in claim 7, wherein the heating device is embedded into the at least one of the bottom structure and the side boundary.

9. The plant as claimed in claim 1, wherein the bottom structure comprises a build platform for components to be produced.

10. The plant as claimed in claim 1, wherein the bottom structure is vertically displaceable with respect to the side boundary.

11. The plant as claimed in claim 9, wherein the bottom structure is sealed at the side boundary by means of a brush seal.

12. The plant as claimed in claim 1, wherein the insulation structure and the structure for the powder bed form a module configured to be inserted in a holding device in the process chamber.

13. The plant as claimed in claim 12, further comprising a plurality of modules which fit into the holding device and differ from one another in respect to the dimensions of the powder chamber.
